(19) United States
(12) Patent Application Publication
(10) Pub. No.: US 2022/0175175 A1
(43) Pub. Date: Jun. 9, 2022

(54) ICED COFFEE SYSTEM

(71) Applicant: Sunbeam Products, Inc., Boca Raton, FL (US)

(72) Inventor: Lauren Stark, Delray Beach, FL (US)

(21) Appl. No.: 17/110,724

(22) Filed: Dec. 3, 2020

(51) Int. Cl. A47J 31/10; A47J 31/44; A47J 31/46; A47G 19/22

(52) U.S. Cl. CPC A47J 31/10; A47G 19/2272; A47J 31/462; A47J 31/4457

(57) ABSTRACT

An iced coffee system hereof provides a simple and convenient system to brew iced coffee. The system includes an iced coffee brewing machine and a multipurpose tumbler. The tumbler may act not only as a drinking vessel when the coffee is ready, but it may also act as a measuring device to measure the right amount of water to be used in the brewing machine and the right amount of ice to use when consuming the iced coffee.

### FIELD OF THE INVENTION

The present invention relates generally to brewing and dispensing coffee. More particularly, the invention relates to a comprehensive system that allows a consumer to conveniently and quickly brew strong, flavorful iced coffee.

### BACKGROUND OF THE INVENTION

Iced coffee is an increasingly popular alternative to traditional hot coffee. Many consumers enjoy iced coffee beverages from coffee shops, while others make their own at home.

Making iced coffee at home usually consists of using a traditional hot coffee brewer to brew hot coffee, and letting the brewed coffee sit (or placing it in the refrigerator) until it is cool. Consumers may then add ice after the coffee has cooled. However, when coffee sits for too long, it oxidizes and loses much of its fresh flavor. Also, adding too much ice, or adding ice at the wrong time, can result in watered-down, bad-tasting coffee. Home brewing iced coffee using a traditional hot coffee brewer can also create too much coffee. Consumers of iced coffee may not necessarily need an entire pot of coffee to prepare the amount of iced coffee they desire.

Existing iced coffee machines designed for in-home use that are available on the market are inconvenient. The brewing process is not straightforward and may require using additional dishware to carry out the brewing process, like a spoon to scoop grounds, a pitcher to pour water into the brewer, a drinking vessel, and a scoop to scoop ice into the drinking vessel. A streamlined, straightforward brewing system is desired that makes the brewing process convenient but does not sacrifice quality or flavor.

### SUMMARY OF THE INVENTION

The iced coffee system hereof provides a simple and convenient system to brew iced coffee at home. The system comprises an iced coffee brewing machine, a multipurpose tumbler, and (in some embodiments) a scoop. The tumbler may act not only as a drinking vessel when the coffee is ready, but it may also act as a measuring device for 1) the right amount of water to be used in the brewing machine and 2) the right amount of ice to use without overdiluting the brewed coffee and preserving some ice for consumption.

To use the system, a user may start by scooping the correct amount of grounds into the machine's basket using the scoop. He or she may then fill the tumbler with water to its designated water line. The water should then be poured into the machine. Prior to initiating the brew process, the user may fill the tumbler with ice to its designated ice line. He or she may then place the tumbler (potentially with its lid off) such that brewed coffee will dispense directly into the tumbler once brewing starts. Once brewing has stopped, a user may add cream, milk, sugar, sweetener, or the like, and then put the lid and straw on the tumbler and begin enjoying his or her iced coffee.

### BRIEF DESCRIPTION OF THE DRAWINGS

For a better understanding of the present invention, reference may be made to the following accompanying drawings.

FIG. 1 is a perspective view of an iced coffee system constructed according to the teachings of the present invention;

FIG. 2 is a bottom perspective view of an iced coffee brewing machine of the iced coffee system of FIG. 1;

FIG. 3 is a perspective view of a scoop that may be used with the iced coffee system of FIG. 1;

FIG. 4 is an elevation view of a tumbler of the iced coffee system of FIG. 1; and

FIG. 5 is a top plan view of an interior of the iced coffee brewing machine of FIG. 2.

### DETAILED DESCRIPTION OF THE INVENTION

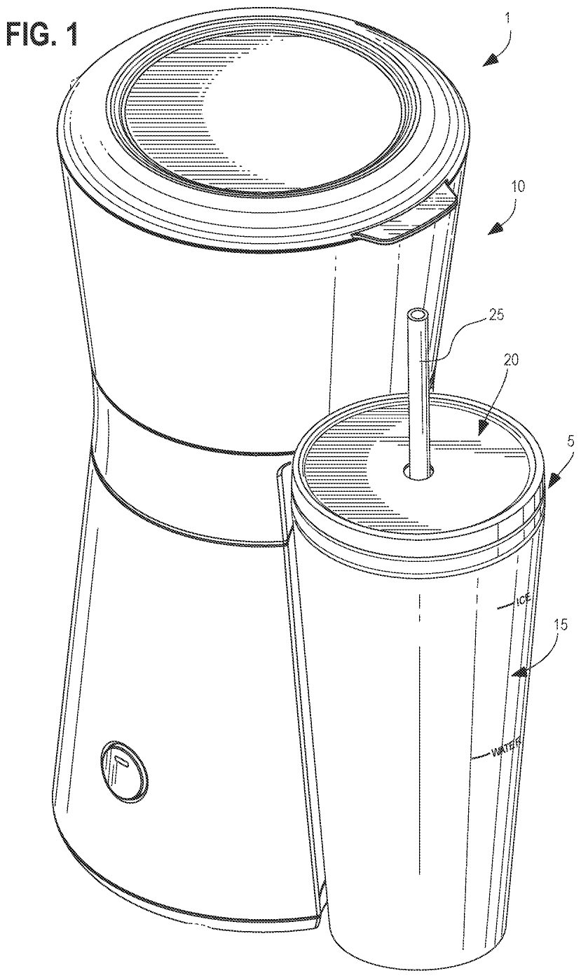

FIG. 1 illustrates an iced coffee system 1 that may be used to brew iced coffee. The system 1 hereof is scaled for brewing and dispensing a single serving of iced coffee, but in alternative embodiments could be scaled for increased brewing and dispensing, as will be appreciated by those skilled in the art.

The system 1 generally includes a tumbler 5 and a brewing machine 10. The tumbler 5 may serve not only as a drinking vessel from which an operator may enjoy his or her coffee, it may also act as a receptacle for receiving brewed iced coffee. It also may act as a measuring device for measuring the proper amount of water that should be added to the brewing machine 10 as well as the amount of ice that should be added to the tumbler 5 prior to brewing. The tumbler 5 may generally include a vessel 15, lid 20, and straw 25.

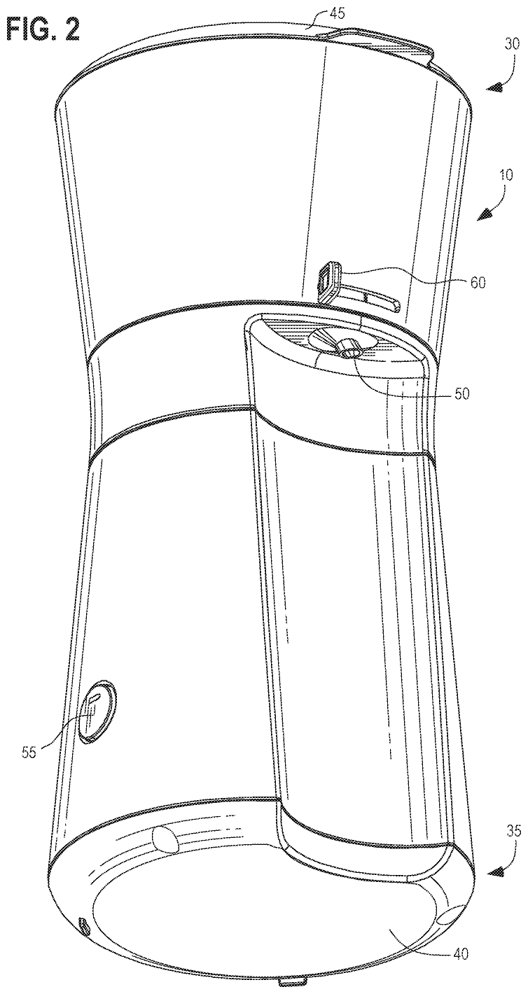

The brewing machine 10 (see FIG. 2) includes an upper portion 30 and a lower portion 35. The lower portion 35 preferably includes a base 40 which may abut a countertop or other surface when the machine 10 is in use. In operation, the machine 10 works like many coffee makers in several respects. Coffee grounds are added to a receptacle within the machine 10 (not illustrated but preferably accessible via a lid 45 at the upper portion 30 of the machine 1). When water is added to the machine 10 (for example via the lower portion 35 when the upper portion 30 is removed, or in some embodiments via the lid 45), and the lid 45 is closed, a user may begin brewing. The system 1 heats up the water, which is dripped over the grounds. Coffee is released at a discharge port 50. In alternative embodiments, a different discharge mechanism may be present in lieu of the discharge port 50. Like known coffee makers, the coffee machine 10 may include a power button 55, a brew strength slider 60 (or a “drip stop”), and other known or foreseeable functions and components.

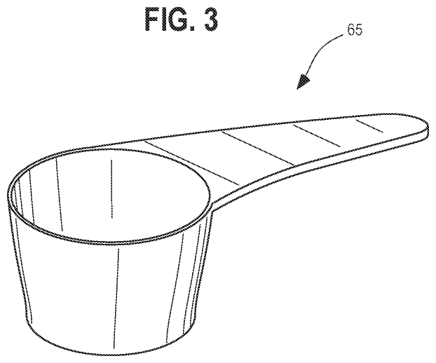

Turning to FIG. 3, a scoop 65 may be provided as part of the system 1. The scoop 65 may have a scoop volume that correlates to a preferred brew strength. In some embodiments, the brewing machine 10 may include a receptacle in which the scoop 65 may be stored when not in use.

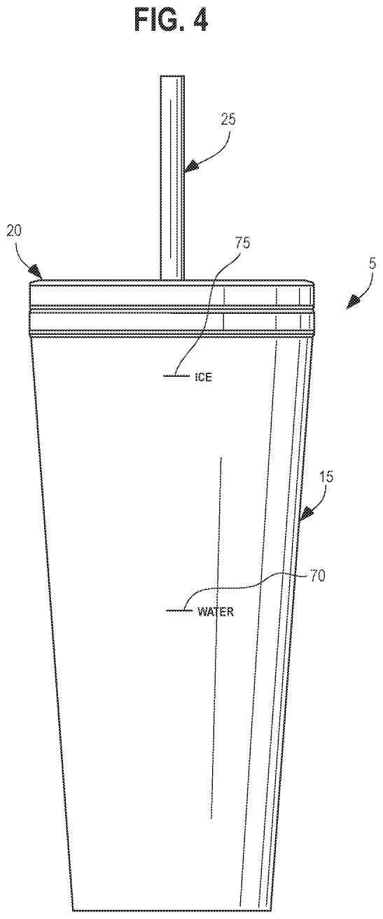

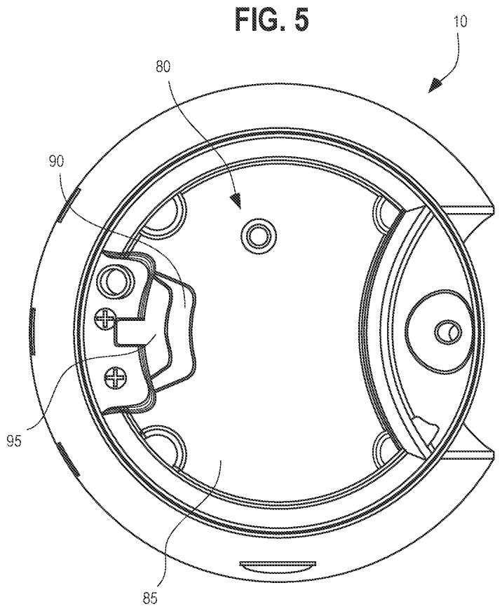

When a user wishes to brew iced coffee using the machine 10, he or she may fill the tumbler 5 (illustrated in FIG. 4) with water to a level at or near a first measuring line 70. He or she may then pour that same volume of water from the tumbler 5 into the machine 10. The recommended volume of water within the tumbler 5 is represented by the first measuring line 70, which may be present on the tumbler 5 or straw. This water is then dumped into the lower portion 35 of the machine 10, shown in FIG. 5 with the top portion 30 removed.

The user may then fill the tumbler to a second measuring line 75 with ice. The second measuring line 75 may be representative of a volume of ice that may be added to the tumbler 5 that will rapidly cools the brewed coffee, but which will not cause the suggested volume of water to overflow the tumbler 5. Such rapid cooling may keep the brewed coffee from oxidizing and losing flavor. The measuring line 75 also may represent a volume of ice that will allow for some melting when it encounters the hot coffee, but not so much that all of the ice will melt given the recommended volume of water.

After initiating the brew process set forth above, the tumbler 5 (with ice) is placed adjacent the brewing machine 10. When iced coffee is brewed using the brewing machine 10 and method described herein, the vessel 15 (with the lid 20 and 25 removed from the vessel 15) may be placed below the discharge port 50 or other drip location from which brewed coffee is dispensed. Once the coffee has been dispensed into the vessel 15, the lid 20 and the straw 25 may be re-coupled to the vessel 15, and the iced coffee is ready for consumption.

An interior 80 of the lower portion 35 of the machine 10 (with the upper portion 30 removed) is illustrated in FIG. 5. The interior 80 of the machine 10 includes a reservoir 85 to which water from the tumbler 5 may be added. Two ledge members 90, 95 preferably extend into the reservoir 85. The ledge member 90 is preferably below the ledge member 95 (nearer the base 40). The ledge member 90 represents the suggested volume of water, corresponding generally to the measuring line 70 on the tumbler 5. The amount of water brews enough iced coffee (given the correct amount of ice in the tumbler 5) to leave room a predetermined amount of space for cream, milk, syrups, and/or other liquid additives. However, a user may add more water up to the ledge member 95, which is a maximum fill indicator, if he or she wishes to enjoy the brewed iced coffee as “black” or without liquid added after the brewing process. This volume may also be labeled on the tumbler 5 in some embodiments. Thus, the ledge member 95 represents the volume of water within the reservoir that would completely fill the tumbler 85 so that the coffee is “black,” leaving little to no room for other liquids after the coffee is brewed.

While the construction of the tumbler 5 may vary, its principal material should be one that can handle cold and warm liquids, and it should have some thermal insulation properties. The machine 10 may also vary in construction and material, but in any event should be capable of brewing coffee using known or reasonably foreseeable methods.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles, and scope of the present invention.

Many changes, modifications, variations, and other uses and applications of the present invention will, however, become apparent to those skilled in the art after considering the specification and the accompanying drawings. All such changes, modifications, variations, and other uses and applications which do not depart from the spirit and scope of the invention are deemed to be covered by the invention, which is limited only by the claims which follow.

1. An iced coffee brewing system, the system comprising:
a brewing machine for brewing the iced coffee; and
a vessel for receiving and containing the iced coffee, the vessel including:
a first measurement line corresponding to a recommended volume of water to be added to the brewing machine, and
a second measurement line corresponding to an amount of ice to be added to the vessel.

2. The system of claim 1, wherein the brewing machine includes a reservoir in which water is poured.

3. The system of claim 2, wherein the reservoir includes an indicator for a recommended volume of water.

4. The system of claim 3, wherein the indicator is a ledge member.

5. The system of claim 2, wherein the reservoir includes an indicator for a maximum volume of water.

6. The system of claim 5, wherein the indicator is a ledge member.

7. The system of claim 1, wherein the system includes a scoop for measuring coffee grounds to be added to the brewing machine.

8. The system of claim 1, wherein the amount of ice corresponds to an amount that prevents brewed coffee from oxidizing.

9. The system of claim 1, wherein the vessel includes a lid member that is selectively engageable to the vessel.

10. The system of claim 1, wherein the vessel includes a lid member that is selectively engageable to the vessel.

11. An iced coffee brewing system, the system comprising:
a brewing machine for brewing the iced coffee; and
a tumbler for receiving and containing the iced coffee, the tumbler including:
a vessel;
a lid member selectively engageable with the vessel;
a first measurement line corresponding to a minimum volume of water to be added to the brewing machine, and
a second measurement line corresponding to an amount of ice to be added to the vessel.

12. The system of claim 11, wherein the brewing machine includes a reservoir in which water is poured.

13. The system of claim 12, wherein the reservoir includes a ledge member positioned to indicate the recommended volume of water.

14. The system of claim 12, wherein the reservoir includes a ledge member positioned to indicate a maximum volume of water.

15. The system of claim 11, wherein the system includes a scoop for measuring coffee grounds to be added to the brewing machine.

16. The system of claim 11, wherein the amount of ice corresponds to an amount that prevents brewed coffee from oxidizing.

17. The system of claim 11, wherein the tumbler includes a third measurement line corresponding to a maximum volume of water to be added to the brewing machine.
